(19) United States
(12) Patent Application Publication
(10) Pub. No.: US 2009/0223906 A1
(43) Pub. Date: Sep. 10, 2009

(54) APPARATUS FOR CLEANING STATIONARY, PERMANENT VERTICAL CYLINDRICAL CARTRIDGES INCORPORATING A FLOAT AFFIXED TO A CENTRAL AND LINEARLY TRAVERSABLE BACKWASH TUBE INCORPORATING SPRAY NOZZLES TO INDUCE ROTATION

(76) Inventor: Gene Hirs, Waterford, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/043,648

(22) Filed: Mar. 6, 2008

(51) Int. Cl. B01D 35/22

(52) U.S. Cl. 210/798; 210/136; 210/411

(57) ABSTRACT

A liquid filter with multiple vertical filter tubes covered with a permanent filter septum that can be backwashed through an inner backwash tube with radial nozzles that rotate the tube and advances it up by a float in the top clean compartment and descends with liquid pressure.

### FIELD OF THE INVENTION

An improved backwash apparatus, such as incorporated into a liquid filtration pressure vessel incorporating a plurality of stationary and permanent cylindrical shaped filter cartridges.

### BACKGROUND OF THE INVENTION

Pressure liquid filters containing a wire mesh or synthetic bag elements are extensively used as a final polishing filter. Settling tanks and pre-filtration often do not remove all existing contaminants which have accumulated during normal fluid flow. Therefore, and during critical machining operations, an absolute removal of all such contaminants is imperative.

Bag filters and other types of cartridge filters are also often employed. Cleaning of these filters require manual labor, including disassembly and replacement of the cartridge elements. Such tasks are time consuming and expensive, both in terms of part and labor costs.

Other permanent element tube filters backwash with the shock introduction of compressed air. This does not work effectively if longer tubes are used, since the liquid does not backwash effectively and most of the backwash simply escapes at the lower end of the element.

### SUMMARY OF THE INVENTION

The present invention discloses an improved backwash apparatus, such as incorporated into a liquid filtration pressure vessel, and which overcomes the difficulty of cleaning longer length (e.g. such as 6 foot long) filter tubes and by backwashing all of the filtration surfaces. The present invention incorporates a backwash tube that both rotates and translates up and down covering the entire filter area of the cartridge. The present invention further covers all the tube area because it is rotates at the same time is linearly translates up and down inside of the stationary and elongated filter cartridges(s).

In this fashion, a 90% reduction in the nozzle and backwash flow can be achieved in comparison to that needed in the event of employing stationary fluid jets. Specifically, and again in the example of filtration vessel with 6′ backwash tube, an embodiment of the present invention is capable of incorporating eight combination rotating and linearly traversing nozzles, thus using a total volume of 16 gallons per minute (GPM) of water. In comparison, a total of 78 stationary nozzles expending 156 GPM would be required in providing the same backwash effect. As such, the present invention results in better use of long tube area filters, with lesser wasted processed water and more efficient cleaning processes.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a cross section of the completed filter with backwash tube and filtration unit including floats; and

FIG. 2 is a control diagram illustrating valve operations necessary for performing the backwashing of the filtration unit.

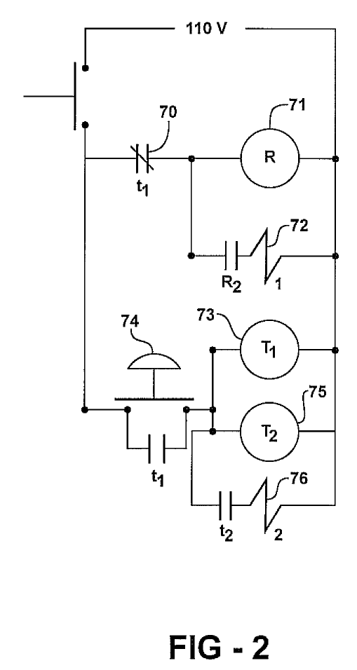

### DETAILED DESCRIPTION OF THE PREFERRED EMBODIMENTS

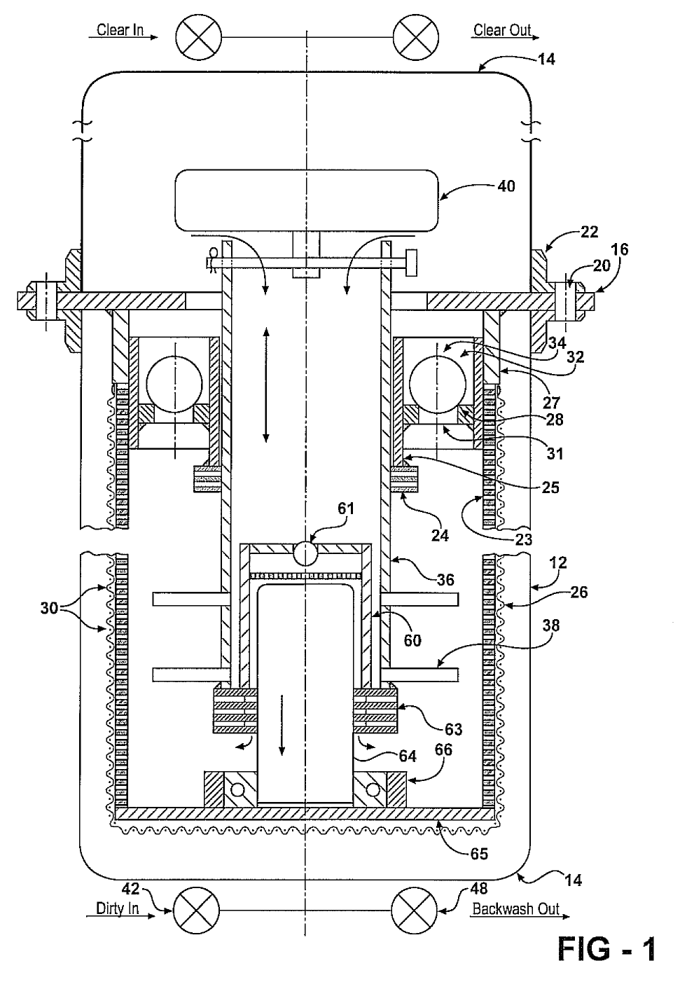

FIG. 1 is a cross section view of the filter vessel and the internal cartridge.

The filter vessel consists of a top head dome section 14, and a bottom tube body section 12, with a platen 16, between them and bolted 20, through flanges 22. Vessel has filter valves 42 and 44 and backwash valves 46 and 48, and a base 65.

The inside of the vessel contains filter cartridges 30, affixed to the platen 16, and disposed vertically. The filtration area consisting of a perforate tube 23, covered with a filter bag 26, made of a polymeric fabric, covering the outside of the perforate tube 23.

The cartridge 30, contains a central backwash tube 36, which is affixed to a float 40, in the top dome 14, and enters the cartridge 30, and is contained in a guide tube 25, and extending downwardly with a series of spray nozzles 38, mostly directed to the filter septum 26, and partially deflected to create a tangential torque for tube rotation.

The cartridge 30, near the top also contains a check valve chamber 28, consisting of a circumferential plate with a series of holes 31, allowing filtrate to move outwardly with polymeric balls 34, and closing the holes during backwash.

The backwash tube 36, contains a hydraulic method for lowering the backwash velocity of the backwash tube by restricting liquid flow from a reservoir chamber 60, near the bottom of the backwash tube.

A reservoir chamber 60, consists of a closed tube 60, inside the lower portion of the backwash tube 36, containing a top compartment 61, with a ball opening the top port when tube is rising and filling the chamber 60, and closing the port 61, on the down stroke.

The reservoir chamber 60, acts like a moving cylinder with a stationary inside piston rod (rod) 64. In the downward wash cycle as the cylinder travels the rod displaces liquid volume from the chamber 60, and is now directed between a close fitting rod and the cylinder. The close fit between the rod and the cylinder starts to cut down the rate fluid is evacuated from the chamber.

Since the volume in the reservoir chamber is small, the hydraulic pressure would lower the tube in less than 5 seconds. To get a practical backwash requires 45 to 60 seconds, a flow control device is used to restrict the discharge of the reservoir chamber.

A flow control valve 63, installed after exiting from the reservoir chamber 60, consists of a series of groves and lands in a tube with a close fitting rod 64. A multiple entry and exit from an orifice reduces flow rate at each stage by 48%. With six stages at 45:1 flow reduction is achieved, which slows the tube decent to approximately 45 to 60 seconds. The rod 64, extending beyond the flow control valve 63, is pressed into a swivel bearing 66, affixed to plate 65, and acts to hold the orifice rod 64, anchors and also adjusts the position of the base of the backwash tube.

FIG. II is an electrical control diagram for operational sequencing of the filter. First it is manually started with switch 70, which energizes relay 71, connected to a solenoid contact R1 operating a four way valve 72, opening filler inlet and outlet valves 42 and 44. The unit now is accepting, filtering and discharging filtrate. As pressure builds up due to accumulation of contaminants and the pressure rises where it trips a pressure switch 74, which is wired in series to a timer 73, with instantaneous contact that drops out the filtration control relay 71 for the duration of the wash cycle, and has parallel contact around the pressure switch keeping the wash cycle operating for approximately 60 seconds. At the same time 73 and 75, get energized and 75 has a 10 second delay contact t2 when no liquid is passing through the filter and allows the float to raise the backwash tube 36, approximately in 10 seconds. After the dwell time timer 75, contact t2 closes the backwash valve 76 and backwash valves 46 and 48 open, which generates a liquid force to lower the tube 36, and rotate it for approximately 50 seconds. At approximately 60 seconds timer T1 73 times out and opens its holding contacts t1 and closes contact t1 in series with filtration relay 71 resulting in the closure of the backwash valves 46 and 48 and opening filtration valves 42 and 44. Normal nitration then resumes.

Having described my invention, other and additional preferred embodiments will become apparent to those skilled in the art to which it pertains and without deviating from the scope of the appended claims:

I claim:

1. An apparatus for backwashing and cleaning at least one stationary and vertical extending cylindrical shaped cartridge, comprising:
a central backwash tube affixed to a float and influenced to travel in a first upward direction prior to backwashing, said backwash tube descending during a succeeding backwashing cycle and additionally rotating by virtue of a plurality of spray nozzles extending outwardly from said backwash tube; and
a rate of backwash tube descent and associated backwash lime during said backwashing cycle being controlled through a flow reducing value affixed to the bottom of the cartridge.

2. The apparatus as disclosed in claim 1, said flow reducing valve further comprising a series of alternating orifices and grooved discs, a stationary control rod extending through an inside of said flow reducing valve and supplying fluid from a reservoir to closely fitting inner wall, surfaces of the valve.

3. The apparatus as disclosed in claim 2, said reservoir further comprising a closed cylinder located in proximity to a base of said backwash tube, said reservoir being filled during upward tube travel by an open check valve in fluid communication with said reservoir.

4. The apparatus as described in claim 1, further comprising a check valve chamber arranged at a top end of the cartridge and allowing filtered liquid to exit and prevents backflow during said backwashing cycle.

5. The apparatus as described in claim 4, further comprising a tube guide associated with the backwash tube affixed to said check valve chamber and having a flow control device at the base for reducing fluid reentry to the cartridge during backwashing.

6. A method for backwashing and cleaning at least one stationary and elongate extending cylindrical shaped cartridge, comprising:
arranging a backwash tube to extend inwardly of the cartridge; and
influencing said backwash tube to travel in a first upward direction prior to backwashing, said backwash tube descending during a succeeding backwashing cycle and simultaneously rotating by virtue of a plurality of spray nozzles extending outwardly from said backwash tube.

7. The method as described in claim 6, further comprising the step of affixing a backwash tube to a float such that said backwash tube will travel in said first upward direction when hydraulic pressure is reduced and will descend when the hydraulic pressure returns.

8. The method as described in claim 7, further comprising the step of controlling said rate of backwash tube descent by a flow control valve by means of reducing flow rate coming from a reservoir by a cylinder in the moving backwash tube and forcing fluid to pass through multiple orifice and grooved plates and reducing flow rate at each stage.

9. The method as described in claim 7, further comprising the step of communicating a fluid flow from a reservoir to a flow control valve during the backwash tube descent in order to reduce flow rate by a ration of 20-50 to 1.

10. The method as described in claim 9, further comprising the step of reducing flow rate through the “Laws of Orifice Flow”, in which flow is reduced by the nature of entering alternately in orifice and groove segments, and which reduce the ratio of liquid flow 48% in each stage.
